(19) United States
(12) Patent Application Publication
(10) Pub. No.: US 2025/0182916 A1
(43) Pub. Date: Jun. 5, 2025

(54) POOL-TYPE REACTOR WITH DRAIN TANK

(71) Applicants: ABILENE CHRISTIAN UNIVERSITY, Abilene, TX (US); GEORGIA TECH RESEARCH CORPORATION, Atlanta, GA (US); The Texas A&M University System, College Station, TX (US); Board of Regents, The University of Texas System, Austin, TX (US)

(72) Inventors: Derek Haas, Austin, TX (US); Jordan Robison, Abilene, TX (US); Steven Biegalski, Atlanta, GA (US); Timothy Head, Abilene, TX (US); Rusty Towell, Abilene, TX (US); Kevin Clarno, Austin, TX (US); Bojan Petrovic, Atlanta, GA (US); Pavel Tsvetkov, College Station, TX (US); Jonathan Scherr, Abilene, TX (US); Mark Kimber, College Station, TX (US)

(21) Appl. No.: 19/041,546

(22) Filed: Jan. 30, 2025

Related U.S. Application Data
(63) Continuation of application No. 18/449,468, filed on Aug. 14, 2023.

(51) Int. Cl. G21C 1/32; G21C 3/54; G21C 7/30

(52) U.S. Cl. CPC G21C 1/32; G21C 7/30; G21C 3/54

(57) ABSTRACT

An integral molten salt nuclear reactor includes a drain tank section configured to hold a volume of fuel salt. The integral molten salt nuclear reactor further includes a reactor section configured to receive the volume of fuel salt from the drain tank and cause fission reactions that heats the molten salt. The integral molten salt nuclear reactor further includes a heat exchange section configured to receive a flow of the heated fuel salt from the reactor section and remove heat therefrom.

### TECHNICAL FIELD

The described examples relate generally to systems, devices, and techniques for an integral molten salt reactor, including reactors in which components functionally associated with the reactor are enclosed with the reactor core.

### BACKGROUND

Molten salt reactors (MSRs) offer an approach to nuclear power that can utilize molten salts as their nuclear fuel in place of the conventional solid fuels used in light water reactors. Advantages include efficient fuel utilization and enhanced safety (largely due to replacing water as a coolant with molten salt). In some MSRs, fission reactions can occur within a molten salt composition housed within a reactor vessel. In certain conventional MSRs, fuel salt undergoes a fission reaction in a reactor vessel. Such conventional MSRs may operate by pumping the fuel salt from the reactor vessel along a “loop,” first to a primary heat exchanger, and then back to the reactor vessel so that the fuel salt may re-enter the reactor vessel for subsequent fission reactions. The reactor vessel, pump(s), heat exchanger(s) and/or other components may be fluidly coupled to one another by a series of pipes, flanges, and other connections, which may each present the possibility for leaks or other failure mechanisms. In some conventional systems, the functional components of the MSR may be arranged fully within an integral enclosure in order to form an integral or “pool-type” reactor whereby the fuel salt circulates between a reactor core and heat exchangers within a common vessel. While such integral reactor may reduce the possibly for leaks and/or other failure mechanisms, such conventional integral reactors may lack the ability to transfer the fuel salt to a subcritical region of the integral vessel. As such, there remains a need for improved MSR systems that provide such functionality.

### SUMMARY

In one example, an integral molten salt nuclear reactor is disclosed. The integral molten salt nuclear reactor includes a drain tank section configured to hold a volume of fuel salt. The integral molten salt nuclear reactor includes a reactor section configured to receive the volume of fuel salt from the drain tank and heat the fuel salt through fission reactions. The integral molten salt nuclear reactor includes a heat exchange section configured to receive a flow of the heated fuel salt from the reactor section and remove heat therefrom.

In another example, the drain tank section, the reactor section, and the heat exchange section may each be sections of a common, integrally constructed vessel.

In another example, the reactor section and the heat exchange section may define a critical region of the vessel. Further, the drain tank section may define a subcritical region of the vessel.

In another example, the drain tank section may include an internal barrier that physically separates the critical region from the subcritical region.

In another example, the internal barrier may define a fuel salt passage configured to allow a flow of fuel salt therethrough and that may be adapted for (i) loading of the fuel salt into the critical region, and (ii) dumping of the fuel salt into the subcritical region.

In another example, in an operational state, the fuel salt may be maintained in the critical region by the internal barrier and an inert gas pressure maintained in the fuel salt passage. Further, in a non-operational state, the inert gas pressure held in the fuel salt passage may be equalized, allowing the fuel salt to exit the critical region and flow, gravitationally, into the drain tank section.

In another example, the vessel may be encompassed by an outer container configured to maintain a vacuum between the vessel and the outer container.

In another example, the reactor may include a heat exchanger arranged in the heat exchange section and fluidly coupled with a coolant salt, gas and/or other heat transfer fluid. In this regard, the coolant salt, gas and/or other heat transfer fluid may be configured to receive heat from the heated fuel salt at the heat exchange section.

In another example, the reactor may include one or more control rods extendable into the reactor section.

In another example, the reactor may include a pair of inert gas lines. The pair of inert gas lines may include a first inert gas line configured to deliver inert gas into the reactor and/or the heat exchange region. The pair of inert gas lines may further include a second inert gas line configured to deliver inert gas into the drain tank section. In this regard, in an operational state, the pair of inert gas lines may be operable to cause a pressure of inert gas in the drain tank section to be higher than a pressure of inert gas in the reactor and/or the heat exchange region. Further, in a non-operational state, the pair of inert gas lines may be operable to cause the pressure of inert gas in the drain tank section to be lower than the pressure of the inert gas in the reactor and/or the heat exchange region.

In another example, an integral molten salt nuclear reactor is disclosed. The integral molt salt nuclear reactor includes a common, integrally constructed vessel defining a critical region and a subcritical region. The critical region defines a critical volume for fission reactions and for the circulation of a fuel salt therethrough. The subcritical region defines a subcritical volume for the storage of the fuel salt away from a reactor core. In this regard, in response to a shutdown event, the fuel salt is passively transferable from the critical volume to the subcritical volume.

In another example, the subcritical region may include a drain tank section having an internal barrier that physically separates the critical volume from the subcritical volume.

In another example, the internal barrier may define a fuel salt passage configured to allow the passive transfer of the fuel salt in response to the shutdown event.

In another example, the fuel salt passage may be pressurizable to maintain the fuel salt in circulation in the critical region during the undergoing of the fission reaction by the fuel salt.

In another example, the critical volume may be adapted to permit circulation of the fuel salt through the critical region by convection.

In another example, the critical volume may be adapted to receive a portion of a pump to induce a mechanically driven flow therethrough.

In another example, a method of operating an integral molten salt nuclear reactor is disclosed. The method includes circulating a fuel salt in a critical region of an integrally constructed vessel that houses fission reactions. The circulating includes removing heat from the fuel salt. The method further includes, in response to a shutdown event, draining the fuel salt to a subcritical region of the integrally constructed vessel.

In another example, the method may further include pressurizing the subcritical region with an inert gas during the circulation of the fuel salt in the critical region, thereby blocking a flow of the fuel salt into the subcritical region during said circulation. In this regard, the method may further include depressurizing the subcritical region with the inert gas, thereby permitting the draining of the fuel salt to the subcritical region.

In another example, the method may further include, prior to the circulating, loading the fuel salt into the subcritical region. In this regard, the method may further include, prior to the circulating, causing the fuel salt to transfer from the subcritical region to the critical region.

In another example, the method may further include, prior to the circulating, heating the critical region using a coolant salt, gas and/or other heat transfer fluid.

In another example, the method may further include, during the circulating, removing heat from the fuel salt of the critical region using the coolant salt, gas and/or other heat transfer fluid.

In addition to the example aspects described above, further aspects and examples will become apparent by reference to the drawings and by study of the following description.

### BRIEF DESCRIPTION OF THE DRAWINGS

FIG. 1 depicts a schematic representation of an example integral molten salt nuclear reactor in a first configuration.

FIG. 2 depicts a schematic representation of the integral molten salt nuclear reactor of FIG. 1 in a second configuration.

FIG. 3 depicts a schematic representation of the integral molten salt nuclear reactor of FIG. 1 in a third configuration.

FIG. 4A depicts another example integral molten salt nuclear reactor.

FIG. 4B depicts another example integral molten salt nuclear reactor.

FIG. 4C depicts another example integral molten salt nuclear reactor.

FIG. 5 depicts a drain tank section of the integral molten salt nuclear reactor of FIG. 4A.

FIG. 6 depicts a reactor section of the integral molten salt nuclear reactor of FIG. 4A.

FIG. 7 depicts a heat exchange section of the integral molten salt nuclear reactor of FIG. 4A.

FIG. 8 depicts a schematic diagram of associated systems of the integral molten salt nuclear reactor of FIG. 4A.

FIG. 9 depicts the integral molten salt reactor of FIG. 4A in a first configuration.

FIG. 10 depicts the integral molten salt reactor of FIG. 4A in a second configuration.

FIG. 11 depicts the integral molten salt reactor of FIG. 4A in a third configuration.

FIG. 12 depicts a schematic diagram including multiple integral molten salt nuclear reactors, such as the integral molten salt reactor of FIG. 4A.

FIG. 13 depicts a flow diagram of a method of operating an integral molten salt nuclear reactor.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to integral or “pool-type” molten salt reactors (MSRs). An “integral” MSR may generally refer to a MSR in which the components of the reactor functionally associated with the reactor may be disposed inside a common enclosure with the reactor core. For example, conventional, non-integral MSR systems, may operate by pumping the fuel salt from the reactor vessel along a “loop,” first to a primary heat exchanger, and then back to the reactor vessel so that the fuel salt may re-enter the reactor vessel for subsequent fission reactions. The reactor vessel, pump(s), heat exchanger(s) and/or other components may be fluidly coupled to one another by a series of pipes, flanges, and other connections, which may each present the possibility for leaks and/or other failure mechanisms. An integral MSR may reduce or eliminate such leaks and/or other failure mechanisms by fully enclosing the functional components (e.g., the heat exchanger, the reactor core, the pump (if used), and so on) within a common, integrally constructed vessel. For example, conventional integral MSRs may house a reactor core and one or more heat exchangers in a common vessel, and cause a fuel salt to circulate within the common vessel between the reactor core (at which the fuel salt may undergo a fission reaction that heats the salt) and a heat exchanger (at which the heat is removed from the fuel salt). However, conventional integral MSRs may maintain the fuel salt in a single “critical region” that is exposed to, or otherwise in fluid contact with, the reactor core at all times. Accordingly, integral MSRs may lack the ability to passively shutdown the reactor in a manner that is considered “walk-away” safe, and, as such, there remains a need for improved MSR systems that provide such functionality.

To mitigate these and other challenges, the integral MSR of the present disclosure includes a critical region and a subcritical region. The critical region may define a critical volume for the circulation of a fuel salt therethrough. The critical region may be the region of the integral MSR at which fission reactions occur. In this regard, the critical region may include various functional components that facilitate the generation of heat, including having a reactor core and one or more heat exchangers disposed therein. The subcritical region may define a subcritical volume for the storage of the fuel salt away from a reactor core of the critical region. The subcritical volume may be physically separated from the critical volume by an internal barrier or other dividing structure so that that fuel salt can be maintained away from the reactor core as needed. For example, during operation of the integral MSR, the fuel salt may be circulated within the critical volume. Then, in response to a shutdown event (including an event in which the integral MSR is shut down under emergency conditions, such as a loss of power), the fuel salt may be passively transferred from the critical volume to the subcritical volume, as described in detail herein.

To facilitate the foregoing, the integral MSRs of the present disclosure may generally include a drain tank section, a reactor section, and heat exchange section. Each of the drain tank section, the reactor section, and the heat exchange section may be sections of a common, integrally constructed vessel or enclosure. The reactor section and the heat exchange section may collectively define the critical region of the integral MSR. The drain tank section may define the subcritical region of the integral MSR. Broadly, the reactor section may operate to cause fission reactions to heat the salt, and the heat exchange section may operate to remove said heat from the fuel salt. The integral MSR may circulate the fuel salt between the reactor section and the heat exchange section continuously, in a loop or a current, in order to continuously produce a flow of heat from the fission reaction that can be used for various purposes, including for power generation.

The drain tank section may be configured to hold a volume of fuel salt and may be a separate section of the integrally constructed vessel that is generally physically separated from both of the reactor section and the heat exchange section. The drain tank section may therefore define a subcritical geometry of the integrally constructed vessel because the drain tank section does not include the reactor core, and, as such, the fuel salt held within the drain tank section is not caused by the integral MSR to undergo a fission reaction or to otherwise be actively heated. In this regard, the drain tank section may be used to hold fuel salt in response to a shutdown event or other event in which it may be desirable for the fuel salt to cease being heated.

As described herein, the integral MSR of the present disclosure may be configured to permit the passive transfer of the fuel salt from the critical volume (e.g., from the heat exchange and reactor sections) to the subcritical volume (e.g., to the drain tank section). In one example, the drain tank section is arranged elevationally below the reactor section and includes an internal barrier that separates the critical region from the subcritical region. Further, the internal barrier may define a fuel salt passage therethrough. In operation, the fuel salt passage may be sufficiently pressurized (such as by an inert gas, including helium) in order to maintain the fuel salt in the critical region. In response to a shutdown event, including a planned shutdown and/or an emergency shutdown (e.g., a loss of power), the fuel salt passage pressure may be equalized with a pressure of the drain tank arranged below. The equalization of the fuel salt passage may cause the fuel salt held therein to drain, gravitationally, into the drain tank section. In this regard, the passive or default state of the integral MSR is defined by the fuel salt being held in the subcritical geometry, and may therefore allow the integral MSR to be considered “walk-away” safe. As further described herein, in response to a start up event, the fuel salt held in the drain tank section may be subsequently transferred to the reactor section by pressurization of the drain tank section (e.g., by establishing a pressure differential in which the drain tank maintains a higher pressure than a pressure of the critical region) in order for the integral MSR to return to an operational state in which integral MSR produces heat from the fission reactions of the fuel salt.

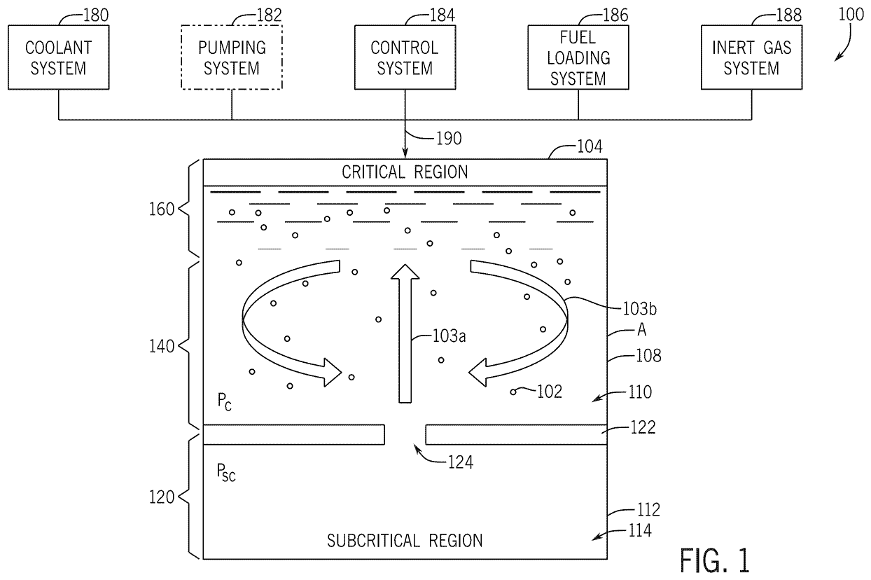

Turning to the Drawings, FIG. 1 depicts a schematic representation of an example integral MSR 100. The integral MSR 100 is shown in a first configuration A in which a fuel salt 102 is circulated in a critical region 108 of the integral MSR 100 for generation and removal of heat caused by fission reactions. A uranium or other fissionable material is mixed with a carrier salt to create the fuel salt 102. In one example, the composition of the fuel salt may be LiF—BeF₂—UF₄, though other compositions of fuel salts may be utilized The integral MSR 100 is shown schematically as including a common, integrally constructed vessel 104. The vessel 104 may define both the critical region 108 and a subcritical region 112. The critical region 108 may define a critical volume 110 for the circulation of the fuel salt 102 and for the housing of fission reactions occurring therein. Further, the subcritical region 112 may define a subcritical volume 114 for the storage of the fuel salt 102 away from a reactor core or otherwise away from the critical region 104. As generally shown in FIG. 1, the critical region 108 may circulate the fuel salt 102 along a circulation flow path therein including a flow 103a through a reactor section 140 where the fuel salt 102 may generally be heated due to fission reactions occurring therein. As further shown in FIG. 1, the critical region 108 may circulate the fuel salt 102 along a circulation path therein including a flow 103b through a heat exchange section 160 and back to the reactor section 140 for recirculation via the flow 103a. At the heat exchange section 160, heat may be removed from the fuel salt 102 in order to circulate a cooler fuel salt 102 back to the reactor section 140 so that the fuel salt 102 may again be heated along the flow 103a. The circulation of the fuel salt 102 along the flows 103a, 103b may proceed continuously in order to provide a generally constant, steady stream of heat from the fission reactions to the heat exchangers of the system 100.

The integrally constructed vessel 104 is shown in FIG. 1 as including the subcritical region 112 therein, which may establish a drain tank section 120 of the integral MSR 100. Accordingly, the integral MSR 100 may be operable to maintain the fuel salt 102 in both a critical state, and a subcritical state, within the same, integrally constructed vessel 104. The subcritical volume 114 of the subcritical region 112 is shown separated from the critical volume 110 by an internal barrier 122. The internal barrier 122 may further define a fuel salt passage 124 therethrough in order to establish a flow path for the fuel salt 102 between the critical volume 110 and the subcritical volume 114.

The fuel salt 102 may be selectively held within the critical volume 110 and/or the subcritical volume 114 based on the maintenance of an inert gas pressure within each volume. For example, the critical volume 110 may be held at a pressure P_{c} and the subcritical volume may be held at a pressure P_{sc}. In the example of FIG. 1, in which the fuel salt 102 is circulated in the critical region 108, the integral MSR 100 may operate to maintain the pressure P_{sc} at a value that is greater than the pressure P_{c}. Accordingly, the fuel salt passage 124 may be pressurized to mitigate or prevent the introduction of fuel salt 102 into the subcritical volume 114 during the first configuration A, shown in FIG. 1. As described herein, the pressures P_{c}, P_{sc} may be manipulated in various manners in order to control the disposition of the fuel salt 102 as between the critical region 108 and the subcritical region 112.

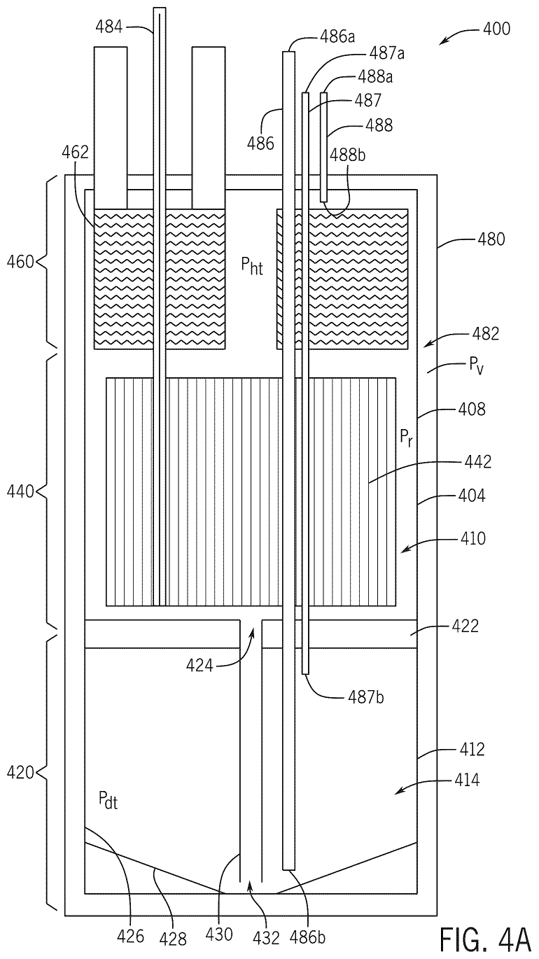

The integral MSR 100 is also shown in FIG. 1 with various associated operational systems, including, but not limited to, a coolant system 180, an optional pumping system 182, a control system 184, a fuel loading system 186, and an inert gas system 188. Each such operational system may be broadly used to control or support one or more functions of the integral MSR 100 that occur in the vessel 104. Accordingly, the schematic diagram of FIG. 1 shows such operational systems as being coupled to the vessel 104 via an operative connection 190. The operative connection 190 may be indicative of any of a variety of mechanical, electrical, and fluidic control and coupling devices (including assemblies and subassemblies thereof), further examples of which are described in greater detail with reference to FIGS. 4A-8 herein.

With reference to the coolant system 180, the coolant system 180 may operate to facilitate the removal of heat from the fuel salt 102 that is circulated through the critical region 108. The coolant system 180 may further operate to facilitate the transfer of such heat to further uses, such as transferring the heat for use in an electricity generation process, a chemical process, and/or any other operation in which heat may be used. For example, the coolant system 180 may include one or more coolant loops that circulate a coolant between the heat exchange section 160 of the critical region 108 and a secondary heat exchanger of the coolant system 180. The coolant receives the heat from the fuel salt 102 and allows such heat to be removed by a secondary coolant at the secondary heat exchanger for transfer of heat to another process.

With reference to the pumping system 182, the pumping system 182 may operate to cause the fuel salt 102 to circulate along the flows of 103a, 103b. For example, the pumping system 182 may include a pump (including a magnetic drive pump) having an impeller at least partially immersed in the fuel salt 102 in order to drive the flow of the fuel salt 102 by operation of the impeller. The pumping system 182 is depicted in phantom line in FIG. 1 and may be an optional component of the integral MSR 100. For example, in some cases, the pumping system 182 may be entirely omitted from the integral MSR 100. In such cases, the integral MSR 100 may be configured to cause the fuel salt 102 to circulate via the flows 103a, 103b via a convective process. For example, as the fuel salt 102 is heated at the reactor section 140, the fuel salt 102 may generally be permitted to rise and follow the flow path 103a. In turn, as heat is removed from the fuel salt 102 at the heat exchange section 160, the fuel salt 102 may generally be permitted to sink and follow the flow path 103b. In some cases, a combination of active pumping and a convective process may be used to facilitate the flows 103a, 103b.

With reference to the control system 184, the control system 184 may include any appropriate components to facilitate reactivity control. In some cases, the control system 184 may include one or more control rods that may be selectively insertable into the critical region 108 of the vessel 104 in order to slow down, or stop, a nuclear reaction occurring therein. Additionally or alternatively, reactivity may be controlled via coolant flow rates and fuel salt level adjustments, either of which may remove the need for control rods.

With reference to the fuel loading system 186, the fuel loading system 186 may operate to load and/or unload the fuel salt 102 into the vessel 104. As described in greater detail herein, such fuel loading system 186 may permit the fuel salt 102 to be first loaded into the subcritical region 112. Then, in response to an operation event, the fuel salt 102 may be transferred to the critical region 108, for example, by control of the pressures P_{c}, P_{sc}. In some cases, the fuel loading system 186, may be configured to reverse the foregoing process and complete one or more steps that causes the fuel to be removed from the vessel 104 For example, the fuel loading system 186 may be operated to pump or otherwise move molten salt from the subcritical volume 114 and to an external dump or waste vessel (not shown in FIG. 1). With reference to the inert gas system 188, the inert gas system 188 may operate to control such pressures P_{c}, P_{sc}. For example, and as described in greater detail herein, the inert gas system 188 may be operatively coupled to a supply of inert gas, such as a helium gas. The inert gas system 188 may be further operated to supply such inert gas, selectively, to each of the critical volume 110 and the subcritical volume 114. As such, the inert gas system 188 may be used to control the pressures P_{c}, P_{sc}, which, as described herein, may be used to cause the fuel salt to be disposed in one of the critical region 108 or the subcritical region 112 based on an operational state of the integral MSR 100.

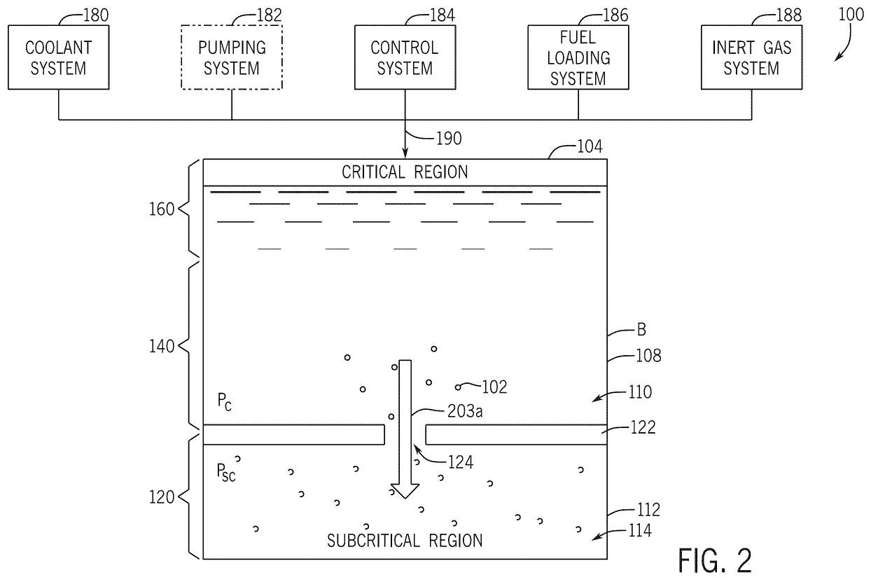

Turning to FIG. 2, a schematic representation of the integral MSR 100 is shown in a second configuration B. In the second configuration B, the fuel salt 102 may be passively transferred to the subcritical region 112. For example, the fuel salt 102 may be caused to progress along a flow 203a that proceeds from the critical region 108 to the subcritical region 112. Transferring of the fuel salt 102 to the subcritical region 112 in this manner may allow the fuel salt 102 to be physically separated from the reactor core and/or other components of the critical region 108. Accordingly, the fuel salt 102 may be held away from such components so that the fuel salt 102 may cease being heated or otherwise be removed from certain fission reactions of the critical region 108.

To facilitate the foregoing, the inert gas system 188 may control the pressures P_{c}, P_{sc}. For example, the inert gas system 188 may cause the pressure P_{sc} to be less than or equal to the P_{c}. As such, the fuel salt passage 124 may become depressurized so that the pressure of the fuel salt passage 124 no longer mitigates or prevents the fuel salt 102 from flowing therethrough. Rather, on the depressurization of the fuel salt passage 124, the fuel salt 102 may gravitationally flow through the fuel salt passage 124 and into subcritical region 112. The integral MSR 100 may therefore be considered “walk-away” safe because the passive or default state or configuration is one in which the fuel salt 102 is held away from the critical region 108 so that the fuel salt 102 is not subject to excessive heating.

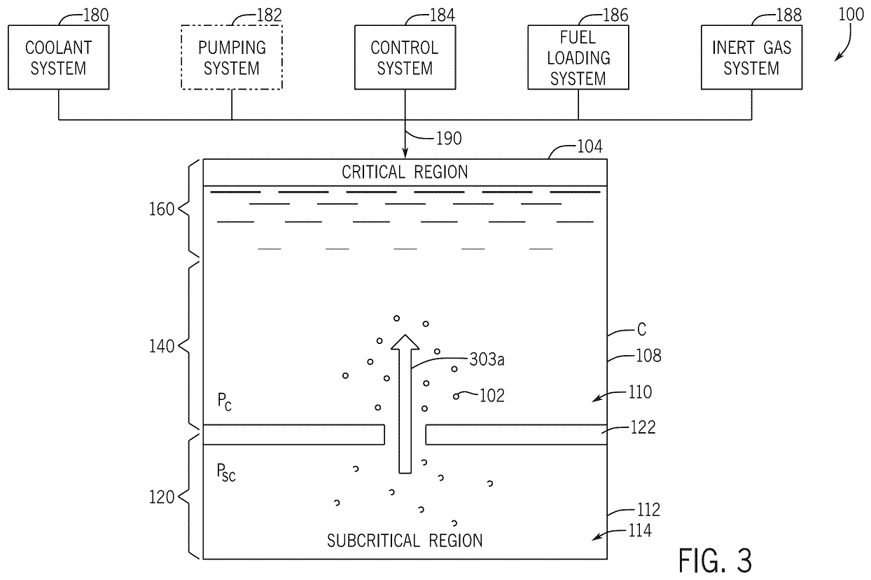

Turning to FIG. 3, a schematic representation of the integral MSR 100 is shown in a third configuration C. In the third configuration C, the fuel salt 102 may be actively transferred to the critical region 108. For example, the fuel salt 102 may be caused to progress along a flow 303a that proceeds from the subcritical region 112 to the critical region 108. Transferring of the fuel salt 102 to the critical region 108 in this manner may allow the fuel salt 102 held in the subcritical geometry to be used in conjunction with fission reactions for the generation of heat in the critical region 108. To facilitate the foregoing, the inert gas system 188 may control the pressures P_{c}, P_{sc}. For example, the inert gas system 188 may cause the pressure P_{sc} to be greater than the pressure P_{c}. As such, the fuel salt 102 held in the subcritical volume 14 may be encouraged to travel through the fuel salt passage 124 and into the critical volume 110. The inert gas system 188 may further operate to maintain the pressure P_{sc} as being greater that the pressure P_{c} so as to maintain the fuel salt passage 124 in a pressurized state such that the fuel salt 102 is mitigated or prevented from entering the subcritical region 112, as described in relation to FIG. 1. Because the act of transferring the fuel salt 102 from the subcritical region 112 to the critical region 108 is the result of active pressurization, upon the loss of such pressure (e.g., due to emergency event, including a loss of power), the fuel salt 102 will be encouraged to passively drain or dump back to the subcritical region 112, for example, using the fuel salt passage 124.

It will be appreciated that the integral MSRs described herein maybe be implemented with a variety of components, systems, and subassemblies. With reference to FIG. 4A, another example integral MSR of the present disclosure is depicted, which may represent one example implementation of the integral MSRs described herein. In this regard, FIG. 4A depicts an integral MSR 400. The integral MSR 400 may be substantially analogous to the integral MSR 100 described above in relation to FIGS. 1-3 and may include an integrally constructed vessel 404, a critical region 408, a critical volume 410, a subcritical region 412, a subcritical volume 414, a drain tank section 420, an internal barrier 422, a fuel salt passage 424, a reactor section 440, and a heat exchange section 460, redundant explanation of which is omitted here for clarity. The integral MSR 400 may be configured to be shipped to a site as a single piece, including being arranged to fit on a semi-tractor trailer such that the integral MSR 400 may be transported to a site using conventional trucking and highway infrastructure.

Notwithstanding the foregoing similarities, the integral MSR 400 is shown in FIG. 4A as including an outer container 480. The outer container 480 may be used to define a containment space about the vessel 404. For example, the outer container 480 may be configured to fully receive the vessel 404 and define a thermal barrier between the vessel 404 and an external environment. The vessel 404 may therefore be arranged in the outer container 480 in order to define an annular space 482 between the vessel 404 and the outer container 480. The annular space 482 may be held at a pressure Pᵥ, which may be a vacuum pressure. In other cases, Pᵥ may be adapted based on the thermal requirements of the integral MSR 400. Additionally or alternatively, the annular space 482 may be configured to receive gas that may be adapted for emergency cooling of the vessel 404, among other uses.

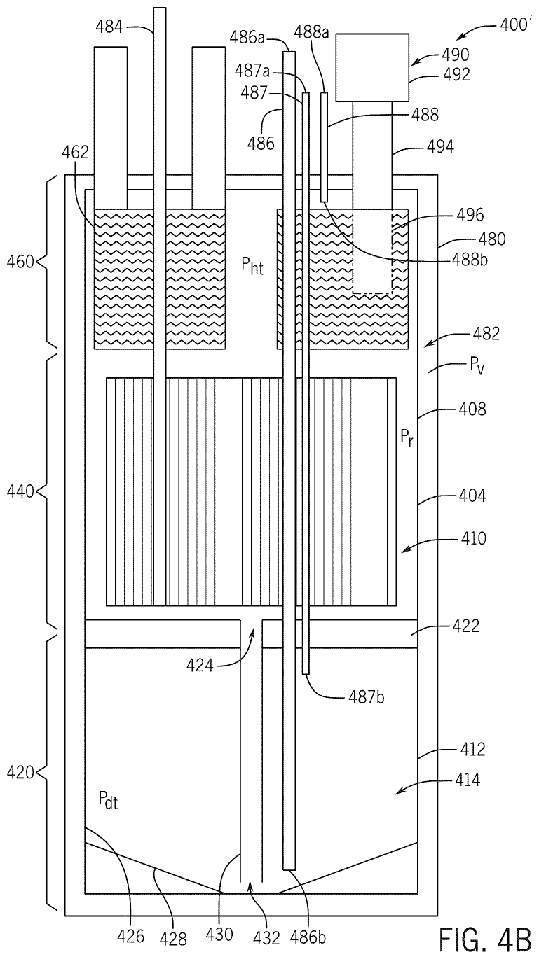

The integral MSR 400 may include a drain tank section 420. The drain tank section 420 may be substantially analogous to the drain tank section 120 described in relation to FIGS. 1-3 and therefore may be configured to hold a volume of fuel salt away from a reactor core and/or other components that occupy the critical region 408 of the integral MSR 400. For example, and with reference to FIGS. 4A and 5, the drain tank section 420 may be configured to hold the fuel salt in the subcritical volume 414, which may generally be defined collectively by the internal barrier 422, drain tank walls 426, and floors 428. With reference the internal barrier 422, the internal barrier 422 may be a structural component that establishes a physical barrier and physical separation between fuel salt held in the critical volume 410 and fuel salt held in the subcritical volume 414. In this regard, the internal barrier 422 may have a sufficient strength and rigidity in order to support a weight of the fuel salt within the critical region 408 without undue deformation or encroachment of the internal barrier 422 into or toward the subcritical volume 414. The internal barrier 422 may further include or be associated with reflective sheets 423. The reflective sheets 423 may be substantially thin sheets arranged between the vessels of the MSR to increase insulation therebetween.

The internal barrier 422 may be adapted to permit the passage of fuel salt between the critical volume 410 and the subcritical volume 414 only via the fuel salt passage 424 defined through the internal barrier 422. In order to permit the transfer of fuel salt between the critical volume 410 and the subcritical volume 414, the drain tank section 420 may further include a transfer pipe 430. The transfer pipe 430 may extend from the fuel salt passage 422 toward a floors 428 of the drain tank section 420. As shown in FIG. 4A, the floors 428 may be sloped to encourage fuel salt toward the transfer pipe 430. For example, an end of the transfer pipe 430 may have a mouth 432 that is disposed adjacent to the floors 428 of the drain tank section 420. In this regard, and as described in greater detail herein, fuel salt can be transferred from the subcritical volume 414 to the critical volume 410 until said fuel salt reaches an elevational level of the mouth 432 in the subcritical volume 414.

As further shown schematically in FIG. 5, the drain tank section 420 may include optional cooling components 413. For example, the drain tank section 420 may require some cooling procedures to remove decay heat. Such cooling procedures can take several forms. In one example, the cooling components 413 may be or include a heat exchanger that is arranged within the annular space 482, about the subcritical volume 404, to remove said decay heat. Such heat exchanger and/or other features of the cooling components 413 may be entirely passive. In some cases, liquid metals or salts could be used as the heat exchange medium, as appropriate for a given application. Such heat exchange medium could be routed through pipes in the annular space 482, and could be driven by natural circulation. Additionally or alternatively, the cooling components 413 may include or be associated with heat pipes.

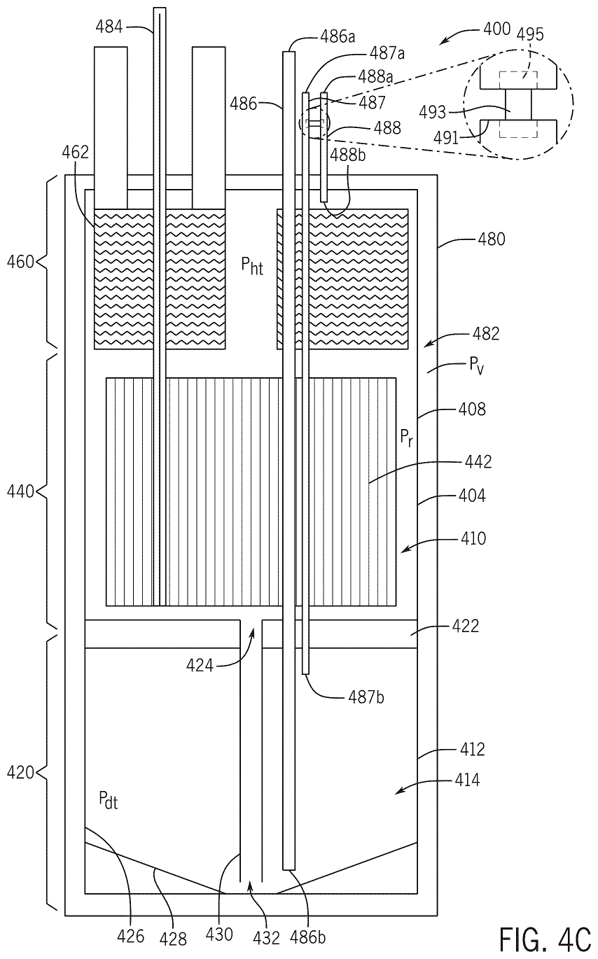

The integral MSR 400 may include the reactor section 440. The reactor section 440 may be substantially analogous to the reactor section 140 described in relation to FIGS. 1-3 and therefore may be configured to receive a volume of fuel salt from the drain tank section 220 and cause fission reactions that heat the fuel salt. For example, and with reference to FIGS. 4A and 6, the reactor section 440 may generally include a reactor core 442 formed at least partially from a moderator material 444, such as a graphite material. The reactor core 442 may cause or otherwise facilitate the undergoing fission reactions in the critical region 408. Accordingly, the reactor core 442 may be constructed in a manner to receive the fuel salt and to cause the fuel salt to be heated therein. In this regard, the reactor core 442 is shown in FIG. 6 as having a fuel salt passage 446 that extends generally from a core bottom side 448a to a core top side 448b. As described herein, the fuel salt may be encouraged to travel through the fuel salt passage 446, and in so doing, the fuel salt may be heated by fission reactions. The reactor core 442 is further shown in FIG. 6 as having peripheral sides 449. The peripheral sides 449 may generally be transverse sides to the core bottom and top sides 448a, 448b. The peripheral sides 449 may be arranged in order to define a core section passage 450 between the reactor core 442 and the vessel 404. As described herein, the fuel salt may be encouraged to travel through the core section passage 450 upon removal of heat from the fuel salt at the heat exchange section 460, and for subsequent recirculation into the core 442.

The reactor core 442 may further includes various components to facilitate various other functions of the integral MSR 400. For example, the reactor core 442 is further shown in FIG. 6 as including a control rod accommodating portion 451. The control rod accommodating portion 451 may be a void or cavity that extends into the moderator material 444 and that is operable to receive one or more control rod structures and/or other structures that are operable to control reactivity of the core 442 (including components that may be used to slow or stop a nuclear reaction in core 442). Further, the reactor core 442 is shown in FIG. 6 as including a fuel loading accommodating portion 452. The fuel loading accommodating portion 452 may be a lumen, duct, or other through passage that allows for one or more fuel loading pipes to extend through the core 442 in order to reach the subcritical volume 414. In this regard, and as described herein, the subcritical volume 414 may be loaded with a fuel salt from a topmost region of the integral MSR 400, passed through the core 442, and stored in the drain tank section 420 below. It will be appreciated, however, that in other examples the fuel loading accommodating portion 452 may be omitted entirely, and the fuel loading lines may be routed to the drain tank around the core 442 (e.g., through the annular space 482). The reactor core 442 is further shown in FIG. 6 as including an inert gas line accommodating portion 453. The inert gas line accommodating portion 453 may be a lumen, duct, or other through passage that allows for one or more inert lines or pipes to extend through the core 442 in order to reach the subcritical volume 414. In this regard, and as described herein the subcritical volume 414 may be pressurized with inert gas from a topmost region of the integral MSR 400. It will be appreciated, however, that in other examples that gas line accommodating portion 453 may be omitted entirely, and the inert gas lines may be routed to the drain tank around the core 442 (e.g., through the annular space 482).

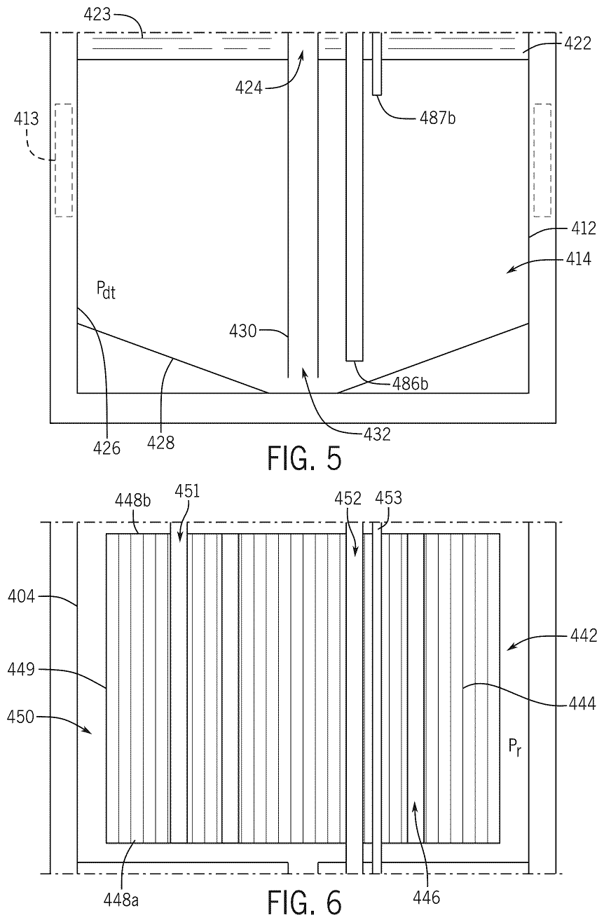

The integral MSR 400 may include the heat exchange section 460. The heat exchange section 460 may be substantially analogous to the heat exchange section 460 described in relation to FIGS. 1-3 and therefore may be configured to receive a flow of the heated fuel salt from the reactor section 440 and remove heat therefrom. For example, and with reference to FIGS. 4A and 7, the heat exchange section 460 is shown as having a heat exchanger 462. The heat exchanger 462 may generally take any of variety of forms in order to transfer heat from fuel salt of the critical volume 410 to a coolant salt or other medium (such as a gas or liquid metal coolant of various types) that is held by the heat exchanger 462. In the example of FIG. 7, the heat exchanger 462 is shown as including a shell 463 having passages 465 that lead into a heat exchange volume 462. Fuel salt (such as that which has been heated from one or more fission reactions) may be routed to the exchange volume 463. Within the volume 463, a coolant pipe run 466 having a coolant salt 467 disposed flowing there through may operate to remove heat from the fuel salt that is arranged in the exchange volume 463. While reference is made herein for purposes of illustration to a “coolant salt,” it will be appreciated that said coolant salt may otherwise be a coolant of any appropriate type, including a gas coolant or a liquid metal coolant, without limitation. In this regard, the coolant pipe run 466 may include a cold leg 468a, an interface section 468b, and a hot leg 468c. The cold leg 468a, the interface section 468b, and the hot leg 468c may cooperate to define a U-shaped member as shown in FIG. 7; however, in other cases, other shapes and configurations are contemplated. The cold leg 468a may be generally include the coolant salt in a reduced temperature format. The interface section 468b may be in contact with the heated fuel salt that traverses through the heat exchanger 462 in the exchange volume 463. In turn, the heat from the heated fuel salt may be transferred to the coolant salt 467 held within the interface section 468b. Subsequently, the coolant salt 467 in elevated temperature format (due to the transfer of heat from the fuel salt) may exit the heat exchanger 464 via the hot leg 468c. As described herein, the elevated temperature coolant salt 467 from the hot leg 468c may be used for a variety of purposes, including electrical power generation, chemical processes, and the like.

The integral MSR 400 may further include a variety of other components to support the operation of the reactor. With reference to FIG. 4A, the integral MSR 400 is shown as including a control rod 484. The control rod 484 may be a calibrated piece of material that is selectively lowered and raised into the reactor 442 in order to reduce or stop a nuclear reaction occurring therein. As further shown in FIG. 4A, the integral MSR 400 may include a fuel load line 486. The fuel load line 486 may be a pipe or conduit that is operable to carry a fuel salt from an environment exterior to the integral MSR 400 to the subcritical volume 414. For example, the fuel load line 486 may including a loading end 486a that is arranged outside of the outer container 480 and that is adaptable to receive a load of fuel salt therein. The fuel load line 486 may further include a dispending end 486b that is arranged within the subcritical volume 414. In this regard, the fuel salt received at the loading end 486a may be routed to through the fuel load line 486 and to the subcritical volume 414 for dispensing thereto via the loading end 486a.

As further shown in FIG. 4A, the integral MSR 400 may include a pair of inert gas lines, including a subcritical gas line 487 and a critical region gas line 488. Each of the gas lines 487, 488 may be operable to control a pressure in the vessel 404. For example, the subcritical gas line 487 may have a loading end 487a that is arranged outside of the outer container 480 and operable to receive a flow of inert gas for routing to a dispensing end 487b that is arranged within the subcritical volume 414. Accordingly, a flow of inert gas can be controlled in order to control a pressure P_{dt} of the subcritical volume 414, thereby controlling a pressure in the drain tank section 420. Further, the critical gas line 488 may have a loading end 488a that is arranged outside of the outer container 480 and operable to receive a flow of inert gas for routing to a dispensing end 488b that is arranged with the critical volume 410. Accordingly, a flow of inert gas can be controlled in order to control a pressure Pₕₜ of the heat exchange section 460 of the critical volume 410, and to control a pressure Pᵣ of the reactor section 440 of the critical volume 410.

The integral MSR 400 shown in relation to FIGS. 4A and 5-7 does not include a pumping mechanism. As described in relation to the integral MSR 100 in relation to FIGS. 1-3, the integral MSR 400 may therefore use convection to induce a continuous circulation of the fuel salt between the reactor section 440 and the heat exchange section 460. In other cases, a pump may be used to support such circulation. In this regard, FIG. 4B depicts an alternative embodiment of an integral MSR 400′ that includes a salt pump 490. The salt pump 490 is shown in FIG. 4B as having a motor 492, a housing 494, and an impeller 496. The salt pump 490 may take a variety of forms, and may be salt-wetted component. Broadly, the motor 492 may cause a shaft (not shown) to drive the impeller 496 and thus induce a flow of fuel salt in the critical volume 410. In some cases, the salt pump 490 may be a magnetic drive pump so as to eliminate the need for mechanical seals and thereby reduce potential leak paths and fail points for the fuel salt via the salt pump 490.

The integral MSR 400 shown in relation to FIGS. 4A and 5-7 does not include a direct fluidic coupling (e.g., a pipe) between the subcritical gas line 487 and the critical region gas line 488. In some cases, it may be desirable to establish a direct fluidic coupling between the subcritical gas line 487 and the critical region gas line 488 in order to facilitate the equalization of pressure between the critical volume 410 and the subcritical volume 412. In this regard, FIG. 4C depicts an alternative embodiment of an integral MSR that includes a cross-link 491 that establishes a fluidic coupling between the subcritical gas line 487 and the critical region gas line 488. During operation, a salt plug 493 or other substance that has an appropriate melting point may be arranged within the cross-link 491 and serve as a plug between the gas lines 487, 488. In the case of the temperature of the system increasing beyond an acceptable level, the salt plug 493 would melt, connecting the gas spaces, equalizing the pressure, and draining the fuel salt naturally into the subcritical volume 412. To facilitate the foregoing functionality, optional cooling components 495 may be arranged about the cross-link 491 and the salt plug 493 in order to maintain the salt plug 493 in solid form during operation of the reactor.

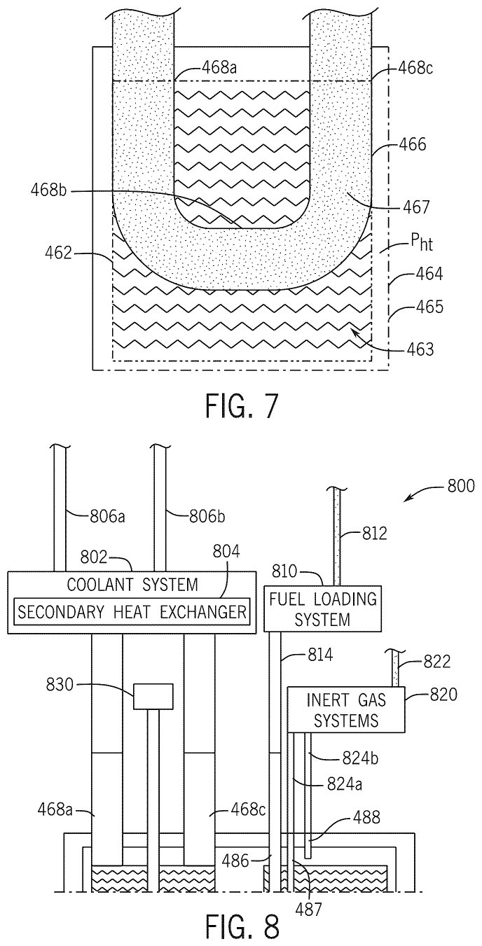

With return reference to the integral MSR 400, the integral MSR 400 may be operated in conjunction with a collection of operational systems that are configured to control one or more functions of the reactor, including controlling heat exchange, fuel loading, inert gas control, and reactivity control, among other functions. In this regard, FIG. 8 depicts a schematic diagram of operational systems 800 that perform these and other functions in support of the operation of the integral MSR 400. For example, such operational systems 800 may include the coolant system 802, a fuel loading system 810, an inert gas system 820, and a reactivity control system 830. The coolant system 802 may generally include any of a variety of components that allows the coolant salt 467 to be exchanged with the heat exchanger 462 within the vessel 404 and to extract heat from said coolant salt 467 for use in additional processes. Accordingly, the coolant system 802 is shown in FIG. 8 as including a secondary heat exchanger 804. The secondary heat exchanger 804 may be any appropriate type of heat exchanger that operates to remove the heat from the coolant salt 467. In this regard, the secondary heat exchanger 804 may receive the hot leg 468c of the coolant pipe run 466, and transfer said heat to a secondary coolant that enters the secondary heat exchanger 804 in a lower temperature format into a cold leg 806a. The secondary heat exchanger 804 may then cause the secondary coolant to exit the coolant system 802 at a secondary coolant hot leg 806b, which may be further routed to various other external processes, including those used for electricity generation, chemical processes, and the like.

FIG. 8 shows the operational systems 800 as including the fuel loading system 810. The fuel loading system 810 may operate to control an initial loading of the fuel salt into the integral MSR 400. For example, the fuel loading system 810 may receive a supply of fuel salt via fuel supply line 812. The fuel loading system 810 may further implement various pumps, valves, controllers and the like to transfer said fuel salt from the fuel supply line 812 to a loading line 814 that is fluidically coupled to the fuel load line 486. The fuel load line 486, as described herein routes and dumps the fuel salt into subcritical volume 414. Upon the initial loading of the fuel salt into the subcritical volume 414, the fuel loading system 810 may be optionally disassociated from the integral MSR 400.

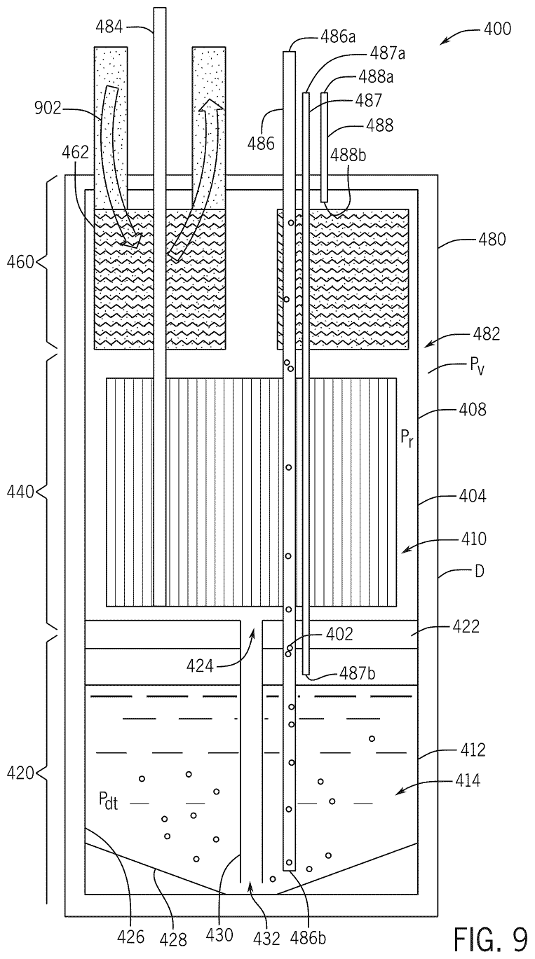

FIG. 8 further shows the operational systems 800 as including the inert gas system 820. The inert gas system 820 may include any of a variety of pumps, compressors, controllers and the like that are configured to cooperate to control the delivery of inert gas to the integral MSR and the maintenance of pressure in the critical region 408 and subcritical region 412. For example, the inert gas system 820 may receive a supply of inert gas from supply line 822. In some cases, the supply line 822 may be coupled to a vessel containing inert gas and/or other source of inert gas. The inert gas system 820 may selectively route the inert gas to one or more loading lines 824a, 824b. The loading line 824a may be fluidly coupled with the subcritical region gas line 487, and as such, flow of inert gas into the loading line 824a may be used to change and/or maintain the pressure P_{dt} of the subcritical region 412 at the drain tank section 420. Further, the loading line 824b may be fluidly coupled with the critical region gas line 488, and as such, flow of inert gas into the loading line 824b may be used to change and/or maintain the pressure Pₕₜ and Pᵣ of the critical region 408 at both of the heat exchange region 460 and the reactor section 440. As described in greater detail herein with reference to FIGS. 9-11, the inert gas system 820 may manipulate the flow of inert gas to each of the loading lines 824a, 824b in order to selectively control a disposition of the fuel salt as between the critical region 408 and the subcritical region 412.

FIG. 8 further shows the operational systems 800 as including the reactivity control system 830. The reactivity control system 830 may include any of a variety of mechanical components that are configured for control of the reactivity control elements described herein. In one example, the reactivity control system 830 may include certain gears, levers, and other mechanisms that allow for the control rod 484 to be selectively raised or lowered into the reactor vessel 404. It will be appreciated that in some cases the control rod 484 may be omitted, and that reactivity control, as contemplated herein, may be accomplished by other means, including by adjusting coolant flow rates and by fuel salt level adjustments, among other techniques.

In operation, the integral MSR 400 may be used to selectively control a disposition of the fuel salt 402 as between the critical volume 410 and the subcritical volume 414. The integral MSR 400 may further in operation be used to generate heat through fission reactions, which heat may be removed through the continuous circulation of fuel salt with the critical volume 410 and through the heat exchange section 460. In this regard, for the sake of illustration, FIG. 9 depicts the integral MSR 400 in a first configuration D. In the first configuration D, the integral MSR 400 may use a coolant salt or gas to heat the vessel 404. For example, the coolant salt 467 may be routed through the heat exchanger 462 along circulation path 902. On startup, in the configuration D shown in FIG. 9, the coolant salt 467 may have an elevated temperature profile as compared to an ambient temperature of the vessel 404, thereby permitting the coolant salt 467 to heat the vessel 404 in the configuration D. In some cases, a heated gas may be used in place of the coolant salt 467 to heat the vessel 404. As is further shown in the first configuration D, the fuel salt 402 may be loaded into the subcritical region 414. For example, the fuel 402 salt may be introduced into the fuel load line 486 (such as via the fuel loading system 810 of FIG. 8) and caused to flow into the subcritical volume 414 via the fuel load line 486.

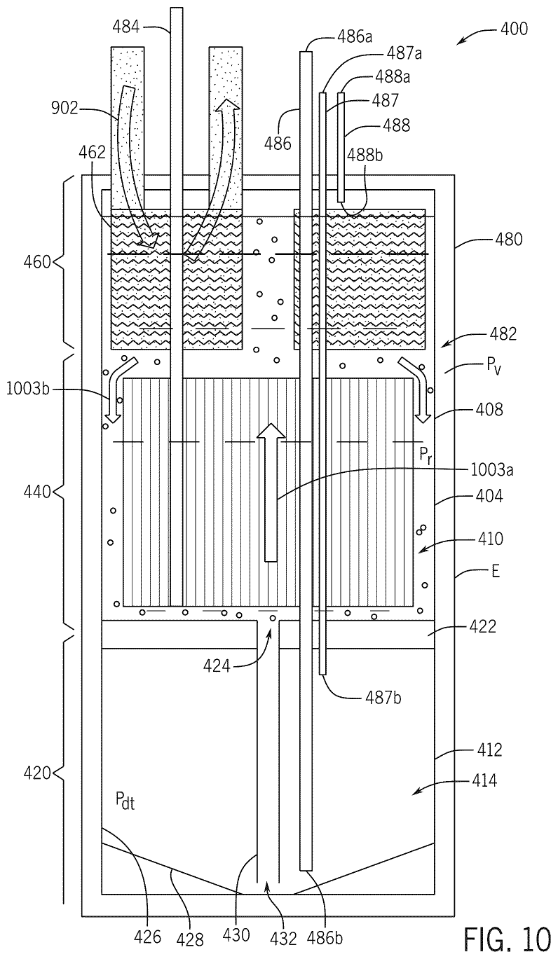

The integral MSR 400 may be further operable to cause the fuel salt 402 to selectively transfer from the subcritical region 414 to the critical region 410. For example, the inert gas lines 487, 488 may be operated (such as via the inert gas system 820 of FIG. 8) in order to control a pressure in each of the critical volume 410 and the subcritical volume 414 and to create a pressure differential therebetween that causes the selective transfer of fuel salt between the critical and subcritical volumes 410, 414. To illustrate, FIG. 10 shows a loading of the fuel salt 402 into the critical volume 410 from the subcritical volume 414 and operation of the integral MSR 400 in a second configuration E. To accomplish said loading, inert gas may be provided to the subcritical region gas line 487 in order to cause the pressure P_{dt} of the subcritical region 412 to increase relative to the pressures Pₕₜ, Pᵣ of the critical region 410. The fuel salt 402 held with the subcritical volume 414 may be exposed to both the pressure P_{dt} and the pressure Pᵣ (via the transfer pipe 430). Accordingly, the pressure differential as between P_{dt} and Pᵣ may induce a flow of the fuel salt 402 from the subcritical volume 414 (having a higher pressure) to the critical volume 410 (having a lower pressure) that causes the fuel salt 402 to transfer from the subcritical volume 414 to the critical volume 410 via the transfer pipe 430. In order to maintain the fuel salt 402 in the critical volume 414, the pressure P_{dt} may be maintained at a higher pressure than either Pᵣ or Pₕₜ during the operation of the reactor. Upon entry of the fuel salt 402 into the critical region 408, the fuel salt 402 may be circulated along a circulation path 1003a extending up through the reactor core 442 where the fuel salt 402 may undergo a fission reaction that heats the fuel salt 402. The fuel salt 402 may be received by the heat exchanger 462 of the heat exchange section 460 from the circulation path 1003a in order to remove the heat from the fuel salt 402, such as via the coolant salt 467 traversing the circulation path 902, as described herein). Subsequently, the fuel salt may proceed along a circulation path 1003b that extends along a periphery of reactor 442, such as through the core section passage 450 in order to return the fuel salt 402 to the reactor core 442 for further fission reactions, operating a continuous loop in this manner during operation of the integral MSR 400.

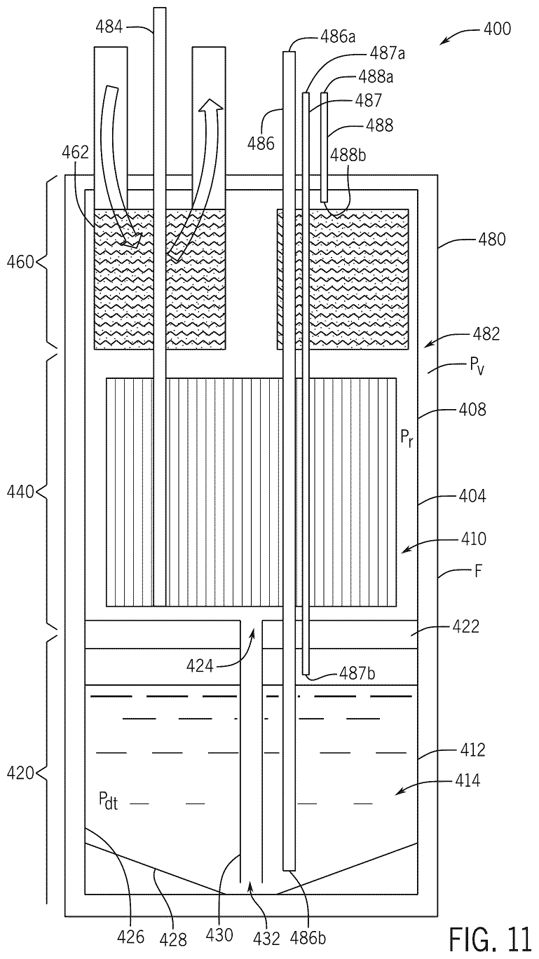

The configuration E of the integral MSR 400 shown in reference to FIG. 10 may be considered an active state of the reactor because the configuration E requires the ongoing, continuous pressurization of the fuel salt passage 424 in order to retain the fuel salt 402 in the critical region 408. Upon depressurization of the fuel salt passage 424 (and upon depressurization of the subcritical volume 414 more generally), the fuel salt 402 may flow, passively and gravitationally from the critical volume 410 to the subcritical volume 414 via the fuel salt passage 424. In this regard, FIG. 11 shows a third configuration F of the integral MSR 400 in which the fuel salt 402 is caused to flow from the critical volume 410 to the subcritical volume 414. For example, the subcritical region gas line 487 and the critical region gas line 488 may be operational in order to cause the pressure P_{dt} to be less than or equal to the pressures Pᵣ, Pₕₜ. On the establishment of such pressures, the fuel salt 402 may no longer be prevented from entering the drain tank section 420, and may therefore flow freely thereto. On flowing freely into the drain tank section 420, the fuel salt 402 may be positioned away from the reactor core 442 and/or generally away from components of the integral MSR 400 that may otherwise cause the fuel salt 402 to be heated. In this regard, the fuel salt 402 may be allowed to be cooled and stored safely during a shutdown event in the subcritical volume 414. Further, the change in pressure P_{dt} may be caused by either an intentional event (e.g., such the lowering of the pressure P_{dt} by the inert gas system 820) or an unintentional event (e.g., an emergency loss of power or other event that results in the failure of the integral MSR 400 to maintain the pressure P_{dt}). Accordingly, the drain tank section 420 may serve as a passive safety system that collects the fuel salt 402 away from the reactor core 442 during an emergency event because said emergency event causes the fuel salt 402 to be routed to subcritical geometry of the drain tank section 420 by default.

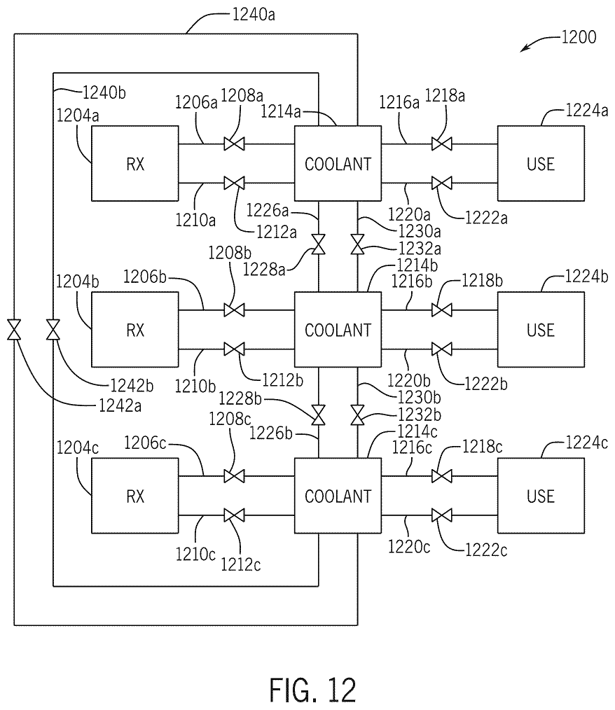

The integral MSRs 100, 400, and/or any of the integral MSRs described herein may be used in combination with multiple integral MSRs in order to form a system for the use of heat generated from such integral MSRs. In this regard, FIG. 12 depicts a system 1200 including a first integral MSR 1204a, a second integral MSR 1204b, and a third integral MSR 1204c. The integral MSRs 1204a-1204c may be substantially analogous to any of the integral MSRs described herein, including the integral MSR 100 of FIG. 1 and/or the integral MSR 400 of FIG. 4A. The integral MSRs 1204a-1204c are each shown coupled to a respective coolant system, such as the first integral MSR 1204a being coupled to a first coolant system 1214a via first coolant system lines 1206a, 1210a, each of which may be selectively closeable by respective first coolant isolation mechanisms 1208a, 1212a (e.g., a control valve). Further, the second integral MSR 1204b is shown being coupled to a second coolant system 1214b via second coolant system lines 1206b, 1210b, each of which may be selectively closeable by respective second coolant isolation mechanisms 1208b, 1212b. Further, the third integral MSR 1204c is shown being coupled to a third coolant system 1214c via third coolant system lines 1206c, 1210c, each of which may be selectively closeable by third coolant isolation mechanisms 1208c, 1212c.

Broadly, each of the coolant systems 1214a-1214c may operate to remove heat from a respective one of the integral MSRs 1204a-1204c. For example, each respective coolant systems 1214a-1214c may run a coolant salt through the corresponding coolant system lines in order to receive heat from a heat fuel salt or other heat medium of the respective integral MSR 1204a-1204c. As further shown in FIG. 12. the coolant systems 1214a-1214c may additionally be coupled to one another. For example, the first coolant system 1214a may be coupled to the second coolant system 1214b via first coolant coupling lines 1226a, 1230a, each of which may be selectively closeable by first coolant coupling isolation mechanisms 1228a, 1232a. Further, the second coolant system 1214b may be coupled to the third coolant system 1214c via second coolant coupling lines 1226b, 1230b, each of which may be selectively closeable by second coolant coupling isolation mechanisms 1228b, 1232b.

In operation, the coupling of the coolant systems 1214a-1214c may allow any of the coolant systems 1214a-1214c to remove heat from any of the integral MSRs 1204a-1204c, as needed. In this regard, the first coolant system 1214a may be operable to remove heat from any of the integral MSRs 1204a-1204c, the second coolant system 1214b may be operable to remove heat from any of the integral MSRs 1204a-1204c, and the third coolant system 1214c may be operable to remove heat from any of the integral MSRs 1204a-1204a. By way of particular example, the first coolant system 1214a may be operable to remove heat from the first integral MSR 1204a via the first coolant systems lines 1206a, 1210a. Further, the first coolant system 1214a may be operable to remove heat from the second integral MSR 1204b via the first coolant coupling lines 1226a, 1230a and the second coolant system lines 1206b, 1210b. Further, the first coolant system 1214a may be operable to remove heat from the third integral MSR 1204c via the first coolant coupling lines 1226a, 1230a, the second coolant coupling lines 1226b, 1230b, and the third coolant system lines 1206c, 1210c.

With reference to the second coolant system 1214b, the second coolant system 1214b may be operable to remove heat from the second integral MSR 1204b via the second coolant system lines 1206b, 1210b. Further, the second coolant system 1214b may be operable to remove heat from the first integral MSR 1204a via the first coolant coupling lines 1226a, 1230a and the first coolant system lines 1206a, 1210b. Further, the second coolant system 1214b may be operable to remove heat from the third integral MSR 1204b via the second coolant coupling lines 1226b, 1230b and the third coolant system lines 1206c, 1210c.

With reference to the third coolant system 1214c, the third coolant system 1214c may be operable to remove heat from the third integral MSR 1204c via the third coolant system lines 1206c, 1208c. Further, the third coolant system 1214c may be operable to remove heat from the second integral MSR 1204b via the second coolant coupling lines 1226b, 1230b and the the second coolant system lines 1206b, 1208b. Further, the third coolant system 1214c may be operable to remove heat from the first integral MSR 1204a via the second coolant coupling lines 1226b, 1230b, the first coolant coupling lines 1226a, 1230a, and the first coolant system lines 1206a, 1210a.

In this regard, should any one or two of the coolant systems 1214a-1214c be inoperative, the heat may be removed from any of the integral MSR 1204a-1204c using the remaining on-line or operational ones of the coolant systems 1214a-1214c. It will be appreciated that while three integral MSRs and a respective three coolant systems are presented in FIG. 12 for purposes of illustration, in other cases, more or fewer integral MSRs and coolant systems may be used.

With further reference to FIG. 12, the system 1200 is shown including multiple uses for the heat captured by the coolant systems 1214a-1214c. For example, FIG. 12 shows a first heat use 1224a which may be coupled to the first coolant system 1214a via first use lines 1216a, 1220a, each of which may be selectively closeable by first use isolation mechanisms 1218a, 1222a. FIG. 12 further shows a second heat use 1224b, which may be coupled to the second coolant system 1214b via second use lines 1216b, 1220a, each of which may be selectively closeable by second use isolation mechanisms 1218b, 1222b. FIG. 12 further shows a third heat use 1224c, which may be coupled to the third coolant system 1214c via third use lines 1216c, 1220c, each of which may be selectively closeable by third use isolation mechanisms 1218c, 1222c. The heat uses 1224a-1224c may be substantially any type of heat use, including those uses associated with electrical power production, desalination, chemical processes, and/or any other type of use, including heat energy storage.

In operation, each of the heat uses 1224a-1224c may receive heat from any of the coolant systems 1214a-1214c. For example, the first heat use 1224a may receive heat from the first coolant system 1214a via the first use lines 1216a, 1220a. The first heat use 1224a may further receive heat from the second coolant system 1214b via the first coolant coupling lines 1226a, 1230a and the first use lines 1216a, 1220a. The first heat use 1224a may further receive heat from the third coolant system 1214c via the second coolant coupling lines 1226b, 1230b, the first coolant coupling lines 1226a, 1230a, and the first use lines 1216a, 1220a. In this regard, should any one of the coolant systems 1214a-1214c be inoperable, the system 1200 may still supply heat to the first heat use 1224a through the other, operational coolant systems, which as described above may each be operable to receive heat from any of the integral MSR 1204a-1204c.

With reference to the second heat use 1224b, the second heat use 1224b may receive heat from the second coolant system 1214b via the second use lines 1216b, 1220b. The second heat use 1224b may further receive heat from the first coolant system 1214a via the first coolant coupling lines 1226a, 1230a, and the second use lines 1216b, 1220b. The second heat use 1224b may further receive heat from the third coolant system 1214c via the second coolant coupling lines 1226b, 1230b and the second use lines 1216b, 1220b. In this regard, should any one of the coolant systems 1214a-1214c be inoperable, the system 1200 may still supply heat to the second heat use 1224b through the other, operational coolant systems, which as described above may each be operable to receive heat from any of the integral MSR 1204a-1204c.

With reference to the third heat use 1224c, the third heat use 1224c may receive heat from the third coolant system 1214c via the third use lines 1216c, 1220c. The third heat use 1224c may further receive heat from the second coolant system 1214b via the second coolant coupling lines 1226a, 1230a the third use lines 1216c, 1220c. The third heat use 1224c may further receive heat from the first coolant system 1214a via the first coolant coupling lines 1226a, 1230a, the second coolant coupling lines 1226b, 1230b, and the third use lines 1216c, 1220c. In this regard, should any one of the coolant systems 1214a-1214c be inoperable, the system 1200 may still supply heat to the third heat use 1224c through the other, operational coolant systems, which as described above may each be operable to receive heat from any of the integral MSR 1204a-1204c. While three such heat uses are shown and described herein, it will be appreciated that in other cases, more or fewer heat uses may be present.

As further depicted in FIG. 12, the system 1200 may include third coolant coupling lines 1240a, 1240b. The third coolant coupling lines 1240a, 1240b may fluidically couple the first coolant system 1214a and the third coolant system 1214c to one another. The third coolant coupling lines 1240a, 1240b may be selectively closeable by third coolant coupling isolation mechanisms 1242a, 1242b. The third coolant coupling lines 1240a, 1240b, in cooperation with the third coolant coupling isolation mechanisms 1242a, 1242b may operate to provide further redundancy to the system 1200. For example, in the event that the second coolant system 1214b is not operational, the coolant medium may still be transferred between the first and second coolant system 1214a, 1214c.

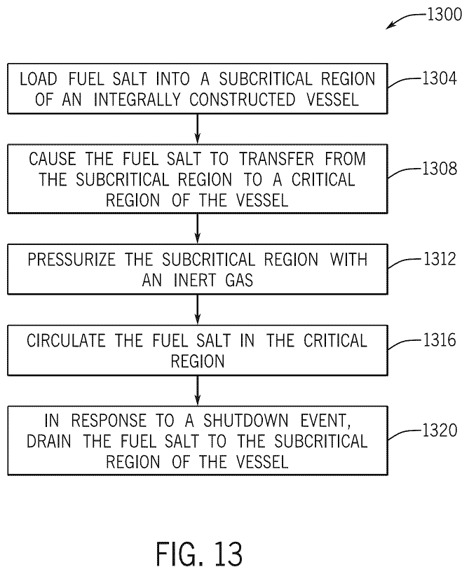

FIG. 13 depicts a flow diagram of a method 1300 of operating an integral molten salt nuclear reactor. At operation 1304, a fuel salt is loaded into a subcritical region of an integrally constructed vessel. For example, and with reference to FIGS. 4A and 9, the fuel salt 402 is loaded into the subcritical volume 414. The fuel salt 402 may be loaded into a loading end 486a of the fuel load line 486 such that fuel salt 402 may be directed to the subcritical volume 414 via the dispensing end 486b. In some cases, the fuel salt 402 of the fuel load line 486 may be pressurized to facilitate the transfer of the fuel salt 402 through the fuel load line 486 optionally in addition to the fuel salt 402 being encouraged into the subcritical volume 414 via gravitational forces.

At operation 1308, the fuel salt is caused to transfer from the subcritical region to a critical region of the vessel. For example, and with reference to FIGS. 4A and 10, the fuel salt 402 may be caused to transfer from the subcritical volume 414 to the critical volume 410. The fuel salt 402 may be transferred from the subcritical volume 414 to the critical volume 410 via the transfer pipe 430, which as shown in FIG. 10 may extend into the subcritical volume 414 such that fuel salt 402 held therein can enter the transfer pipe 430 via the mount 432. To facilitate the foregoing transfer, the pressure P_{dt} may be manipulated relative to the pressure Pₕₜ, Pᵣ such that that pressure P_{dt} is greater that both pressures Pₕₜ, Pᵣ. For example, inert gas may be caused to enter the subcritical volume 414 in a manner that increases the pressure P_{dt} beyond either of Pₕₜ or Pᵣ. Because the fuel salt may be fluidically exposed to both the pressure P_{dt} (in the subcritical volume 414) and the pressure Pₜ (via the transfer pipe 430), the pressure differential may encourage the fuel salt 402 transfer to the lower pressure of the reactor section 440.

At operation 1312, the subcritical region is pressurized with an inert gas. For example, and with continued reference to FIGS. 4A and 10, the pressure P_{dt} of the subcritical volume 414 may be increased in order to mitigate or prevent fuel salt 402 that is held with the critical volume 410 from entering the subcritical volume 414. In some cases, such pressurization of operation 1312 may occur as the result of the continuous entry of pressurized inert gas into the subcritical volume 414 via the subcritical region inert gas line 487. In this regard, in order to maintain the fuel salt 402 within the critical volume 410, the integral MSR 400 may be required to continuously maintain such pressurized state of the subcritical volume 414.

At operation 1316, the fuel salt is circulated in the critical region, which may house certain fission reactions. For example, and with continued reference to FIGS. 4A and 10, the fuel salt 402 may be circulated throughout the critical volume 410 and along the flow paths 1003a, 1003b. Along the flow path 1003a, the fuel salt 402 may be heated as a result of various fission reactions occurring with the reactor section 440. Along the flow path 1003b, the heat form of the fuel salt 402 may interact with one or more heat exchangers of the heat exchange section 460 such that heat is removed from the fuel salt 402. The fuel salt 402 may continue along the flow path 1003b for re-circulation and re-entry into the reactor section 440 for subsequent re-heating.

At operation 1320, in response to a shutdown event, the fuel salt is drained to the subcritical region of the vessel. For example, and with reference to FIGS. 4A and 11, in response to a shutdown event, including a loss of power event, down time event for maintenance, or any other event in which it is desirable for fission reactions to cease, the fuel salt 402 may be drained from the subcritical volume 414 from the critical volume 410. For example, on such shutdown event, the subcritical volume 414 may cease to be pressurized, such as ceasing to be pressurized due to a supply of inert gas from the subcritical region gas line 487 ceasing to supply inert gas to the subcritical volume 414. On such cessation, the subcritical volume 414 may no longer be pressurized in a manner that would prevent the fuel salt 402 from returning to the subcritical volume 414 from the critical volume 410. As such, the fuel salt 402 may drain into the subcritical volume 414 from the critical volume 410 via the transfer pipe 430. Draining the fuel salt in this manner may separate the fuel salt 402 from the reactor section 440 such that the fuel salt 402 is no longer subjected to fission reactions and is no longer heated. In this regard, the fuel salt 402 may default to a safe disposition within the integral MSR 400 on such shutdown even, including a loss of power event, thereby supporting the integral MSR 400 as being walk-away safe.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1.-20. (canceled)

21. A system comprising
a first molten salt reactor system configured to heat a first secondary coolant medium;
a second molten salt reactor system arranged with the first molten salt reactor system and configured to heat a second secondary coolant medium; and
an electrical power production system operably coupled with each of the first molten salt reactor system and the second molten reactor system and configured to generate an electrical power output using heat derived from both of the first and second secondary coolant mediums.

22. The system of claim 21, wherein
the first molten salt reactor comprises
a first reactor core, and
a first fuel salt configured to exhibit an increased temperature upon undergoing fission reactions within the first reactor core, wherein the first fuel salt heats the first secondary coolant medium upon exit from the first reactor core, and
the second molten salt reactor comprises
a second reactor core, and
a second fuel salt configured to exhibit an increased temperature upon undergoing fission reactions with the second reactor core, wherein the second fuel salt heats the second secondary coolant medium upon exit from the second reactor core.

23. The system of claim 22, wherein
each of the first reactor core and the second reactor core are formed from a graphite material defining a respective plurality of vertical flow channels therethrough, and
the first and second fuel salts undergo fission reactions within the respective plurality of vertical flow channels.

24. The system of claim 22, wherein each of the first and second fuel salts flow through the first reactor core and the second reactor core, respectively, via a mechanically induced flow.

25. The system of claim 24, further comprising
a first salt pump configured to provide said mechanically induced flow to the first fuel salt, and
a second salt pump configured to provide said mechanically induced flow to the second fuel salt.

26. The system of claim 21, wherein
the system further comprises a third molten salt reactor system arranged with the first and second molten salt reactor systems and configured to heat a third secondary coolant medium, and
the electrical power production system is operably coupled to each of the first molten salt reactor system, the second molten salt reactor system and the third molten salt reactor system and is configured to generate the electrical power output using heat derived from all of the first, second and third secondary coolant mediums.

27. The system of claim 21, wherein each of the first secondary coolant and the second secondary coolant transfer heat out from a primary containment barrier of the first and second molten salt reactor system, respectively.

28. The system of claim 27, wherein
each of the first secondary coolant medium and the second secondary coolant medium, transfer heat out from the respective primary containment barrier and to, respectively
a first coolant system, and
a second coolant system, and
the first and second coolant systems are arranged outside of the primary containment barrier.

29. The system of claim 28, further comprising
the first coolant system, the first coolant system including a first secondary heat exchanger therein configured to transfer heat from the first secondary coolant medium to a first tertiary coolant medium, and
the second coolant system, the second coolant system including a second secondary heat exchanger therein configured to transfer heat from the second secondary coolant medium, to a second tertiary coolant medium.

30. The system of claim 29, wherein each of the first tertiary coolant medium and the second tertiary coolant medium are each routed for electricity generation by the electrical power production system.

31. A system comprising
a first coolant system configured to remove heat from a first molten salt reactor system using a first tertiary coolant medium;
a second coolant system arranged with the first coolant system and configured to remove heat from a second molten salt reactor system using a second tertiary coolant medium; and
an electrical power production system operably coupled to each of the first coolant system and the second coolant system and configured to generate an electrical power output using heat derived from both of the first tertiary coolant medium and the second tertiary coolant medium.

32. The system of claim 31, wherein
the first coolant system comprises a first secondary heat exchanger separate from, and radioactively shielded from, a first primary heat exchanger of the first molten salt reactor system, and
the second coolant system comprises a second secondary heat exchanger separate from, and radioactively shielded from, a second primary heat exchanger of the second molten salt reactor system.

33. The system of claim 32, wherein
the first secondary heat exchanger is configured to transfer heat from a first secondary coolant medium to the first tertiary coolant medium, the first secondary coolant medium delivering, via heat transfer at the first primary heat exchanger, heat generated at the first molten salt reactor system, and
the second secondary heat exchanger is configured to transfer heat from a second secondary coolant medium to the second tertiary coolant medium, the second secondary coolant medium delivering, via heat transfer at the second primary heat exchanger, heat generated at the second molten salt reactor system.

34. The system of claim 33, wherein the heat generated at the first and second molten salt reactor systems is generated via fission reactions occurring within respective first and second molten fuel salts enroute through graphite moderator defined flow channels.

35. The system of claim 33, further comprising
the first molten salt reactor system, and
the second molten salt reactor system.

36. A method comprising
heating a first secondary coolant medium using a first molten salt reactor system;
heating a second secondary coolant medium using a second molten salt reactor system, the second molten salt reactor system arranged with the first molten salt reactor system; and
generating an electrical power output, via an electrical power production system, using heat derived from both of the first and second secondary coolant mediums.

37. The system of claim 36, wherein
the first molten salt reactor system comprises
a first reactor core, and
a first fuel salt,
the method further includes
causing fission reactions within the first fuel salt, and
heating the first fuel salt using the first reactor core, wherein the first secondary coolant medium is heated using the heated first fuel salt,
the second molten salt reactor system comprises
a second reactor core, and
a second fuel salt, and
the method further includes
causing fission reactions within the second fuel salt, and
heating the second fuel salt using the second reactor core, wherein the second secondary coolant is medium is heated using the heated second fuel salt.

38. The system of claim 37, wherein
the heating of the first fuel salt comprises flowing the first fuel salt through a plurality of graphite moderator flow channels defined through the first reactor core, and
the heating of the second fuel salt comprises flowing the second fuel salt through a plurality of graphite moderator flow channels defined through the second reactor core.

39. The system of claim 38, further comprising
flowing the first fuel salt through the plurality of graphite moderator flow channels of the first reactor core using a first salt pump, and
flowing the second fuel salt through the plurality of graphite moderator flow channels of the second reactor core using a second salt pump.

40. The system of claim 36, wherein
the method further comprises heating a third secondary coolant medium using a third molten salt reactor system, the third molten salt reactor system arranged with the first and second molten salt reactor systems, and
the generating of the electrical power output further comprises generating the electrical power output, via the electrical power production system, using heat derived from each of the first, second and third secondary coolant mediums.
